(19) United States
(12) Patent Application Publication
(10) Pub. No.: US 2010/0222721 A1
(43) Pub. Date: Sep. 2, 2010

(54) Apparatus for application of trigger point pressure in personal fitness Center and the like before or after exercise

(76) Inventors: Robert Schwartz, Boca Raton, FL (US); Todd A. Wolf, Weston, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 12/800,159

(22) Filed: May 10, 2010

Related U.S. Application Data
(63) Continuation-in-part of application No. 12/315,661, filed on Dec. 8, 2008.

(51) Int. Cl. A61H 1/00

(52) U.S. Cl. 601/46

(57) ABSTRACT

The apparatus includes an array of trigger point probes symmetrically positioned about a central vertical plane of the apparatus, the array including at least two of a pair of upper neck pair of probes, an upper back and shoulder blade pair of probes, a mid back pair of probes, and a lower back pair. Over the probes is Therein is provided a shell resembling the appearance of a human back, the shell provided with apertures sufficient in dimension and location to permit slidable passage of ends of the probes thru the shell. The probes are secured, at a base thereof to a vibratory vertical plane which is secured to a non-vibratory vertical plane secured to a wall. The non-vibratory plane includes lateral extensions that extend to form left and right handles by which a user of the apparatus may select and maintain locations of the back requiring application of pressure to release of trigger point contractions and the like.

### CROSS REFERENCE TO RELATED APPLICATION

This application is a continuation-in-part of application Ser. No. 12/315,661, filed Dec. 8, 2008, and the same is herein incorporated by reference in its entirety.

### FIELD OF THE INVENTION

The invention relates to a device based upon principles of trigger point therapy, particularly adapted for utility in physical fitness centers.

### BACKGROUND OF THE INVENTION

The present invention addresses the need for an effective, convenient and affordable trigger point therapy article useful particularly in physical fitness centers during periods prior to or after a workout. In other words, use to contribute to the process of loosening up or stretching before exercise as well as to minimize the formation of troublesome muscle knots, aches or the like before or following a period of exercise.

So-called trigger point or referred pain is generally the result of contracted knots in muscle tissue, known as trigger points. A trigger point is a small contraction in muscle fiber which, to the finger tips, feels like a small bump or lump and can range in size from a pin head to that of a walnut. Trigger point contraction affects muscles by keeping them tight and weak and often by generating referred pain to nearby areas. This occurs because a muscle which is too tight causes a constant tension upon muscle fibers which, in turn, produce symptoms in adjacent joints, ligaments or other tissue. Results thereof may be limitations in range of motion of the muscle as well as compression of blood vessels and nerves, this causing such symptoms as headaches, neck pain, upper and lower back pain, and other symptoms which are often erroneously ascribed to arthritis, tendonitis, bursitis, or ligament injury.

The prior art, as exemplified by U.S. Application Publication US2008/0139981 (2008) to Walquist et al, entitled Trigger Point Therapy Device, teaches that self-applied trigger point therapy can be effective and can accomplish at least three benefits, namely, breaking into the chemical and neurological feedback loop that maintains proper muscle contraction; increasing circulation that has been restricted by contracted tissue; and directly stretching knotted muscle fibers of the trigger point itself. It is noted that the structure of Walquist does not afford the strength, stability, or safety of use necessary in a fitness center environment.

Self-treatment of trigger point issues is often preferable to professional therapy if a condition can be addressed before it becomes too severe. The consequences of non-treatment can be highly adverse and can include the need for pain medication, surgery, electrotherapy, injections, chiropractic treatment, and acupuncture procedures.

The present invention addresses self-therapy, however through the use of a relatively simple mechanical device in the nature of a rigid board which is attached to a wall. In a preferred use, this wall is located within a physical fitness facility so that it may be used for both preventative and therapeutic purposes. The use of the inventive device however is not limited to health spa facilities. Further, the inventive device, unlike prior art such as Walquist, does not require continual repositioning or selection of a trigger point probe by the end user. Examples of devices in the art which exhibit this same limitation include UK Published Patent Specification No. 1,410,944 (1975) to Lloyd, entitled Massage Board; and WIPO Publication WO 02/05742 A1 (2002) to Campbell, entitled Apparatus For Massaging A Human Body. Other prior art which requires continual repositioning of an acupressure, trigger point or massage probe are U.S. Pat. No. 4,452,237 (1984) to Lewis, entitled Self Acupressure Apparatus; U.S. Application Publication US 2004/0106882 (2004) to Tseng, entitled Kneading Massage Structure; and U.S. Pat. No. 7,320,778 (2008) to Warder, entitled Whole Body Massage Tool Utilizing Gravity For Energy.

Further, none of the above references are practical for purposes of use in a health spa facility because of the personalization of the trigger point probes needed before the device can be used.

Certain therapeutic massage devices for use in conjunction with hydrotherapy are known in the art as, for example, are represented by U.S. Pat. No. 5,899,868 (1999) to VandeBerg, entitled Deep Muscle Knot Relaxing Device and Methods; and U.S. Application Publication U.S. 2004/0078885 (2004) to Walker, entitled Tactile Therapy System For Spas. The latter is more particularly directed to reflexology of the hand or foot in conjunction with hydrotherapy. The probes of VandeBerg are not optimized to address trigger point contraction. Related devices of this character directed to reflexology only are represented by U.S. Pat. No. 4,852,553 (1989) to Voykin.

There exist a small number of prior art devices which employ a board or substrate and with which a self-administered back massage may be effected. These are U.S. Application Publication US 2002/0068888 (2002) to Wang; and U.S. Pat. No. 7,087,004 (2006) to Berke, entitled Self-Administered Back Massage. Both of these devices address only a small area of the back and the probes thereof are not adapted in shape to treat trigger point issues as set forth herein.

While the above reference to VandeBerg relates to deep a muscle knot-relaxing device, the probes thereof are always positioned at a fixed distance relative to each other and, more importantly, are designed to assure that only one probe at a time is employed. In distinction, the present invention is intended to assure that a minimum of two probes at a time, and often several, are operative at the same time. Accordingly, while VandeBerg recognizes the importance of trigger points that exist in a human back, it does not provide a solution practical for use in a physical fitness facility in which only limited time is available to relieve pressure upon many different trigger points. As such, VandeBerg does not recognize that deep muscle fiber spreading to relieve muscle knots at trigger points can be addressed on a multiple location basis to yield both multiple, synergistic and more efficient benefits. The functionality of Vandeberg is also reliant upon its use in association with hydrostatic pressure beneath the base thereof.

The within invention addresses these deficiencies in the prior art.

This and other objects and advantages of the invention will become apparent from the Detailed Description of the Invention, the Drawings and Claims that follows.

### SUMMARY OF THE INVENTION

The apparatus includes an array of trigger point probes symmetrically positioned about a central vertical plane of said apparatus, said array comprising at least two of a pair of upper neck pair of probes, an upper back and shoulder blade pair of probes, a mid back pair of probes, and a lower back pair. Thereupon is provided a shell resembling the appearance of a human back. Said shell is provided with a plurality of apertures sufficient in dimension and location to permit slidable passage of ends of said probes thru said shell. Said probes are secured at a base thereof to a vibratory vertical plane secured to a non-vibratory vertical plane secured to a wall. Said non-vibratory plate includes lateral extensions that extend to form left and right handles by which a user of said apparatus may select locations of the back requiring application of pressure to release of trigger point contractions and the like.

It is an object of the present invention to provide an apparatus particularly adapted for use in personal fitness centers, to accomplish the application of pressure to muscular knots and the like, clinically known as trigger points.

It is another object to provide an effective, convenient and affordable apparatus for the accomplishment of both trigger point therapy and to assist in loosening-up or stretching before exercise to minimize the potential for the formation of muscle knots or trigger points as a result of exercise.

It is a further object of the invention to provide a device particularly adapted for self-application of muscle knot therapy through the application of cross-fiber friction, clinically known as petrissage.

It is a yet further object to provide an apparatus of the above type particularly adapted to access pressure points by simple vertical and horizontal motion by a user of his back against the inventive apparatus.

A further object of the present invention is to provide apparatus for self application of pressure to multiple groups of trigger points at the same time.

The above and yet other objects and advantages will become apparent from the hereinafter set forth Brief Description of the Drawings, Detailed Description of the Invention and Claims appended herewith.

### BRIEF DESCRIPTION OF THE DRAWINGS

FIG. 1 is a front elevational view of the inventive device.

FIG. 2 is a side breakaway view of the inventive apparatus for application of pressure to trigger points of the human back.

FIG. 3 is a front elevational view of the inventive apparatus with the front housing thereof removed.

FIG. 4 is a diagonal perspective view of the vibration inducing portion of the inventive apparatus.

FIG. 5 is a top plan view of the assembly shown in FIG. 4.

FIG. 6 is a back elevational view of the assembly shown in FIG. 4.

FIG. 7 is a vertical cross-sectional view showing therein the geometry of the trigger point probes of the invention.

FIG. 8 is a schematic physiologic view of selected trigger points of the upper back and shoulder blade area addressed by the device, as is more fully set forth herein.

FIG. 9 is a schematic physiologic view showing trigger points in the area of shoulder and lower blades, as is more fully set forth herein.

FIG. 10 is a rear physiologic view showing trigger points of the mid and lower back, as is more fully addressed below.

FIG. 11 is a schematic physiologic view of the back showing additional trigger points addressed by the invention.

FIG. 12 is a schematic physiologic view of trigger point contractions within a group of muscle fibers.

FIG. 13 is a schematic view showing the effect of the apex of a probe of the invention to apply pressure to a contracted trigger point of within muscle fibers shown in FIG. 12.

FIG. 14 is a front plan view of a further embodiment of the invention.

### DETAILED DESCRIPTION OF THE INVENTION

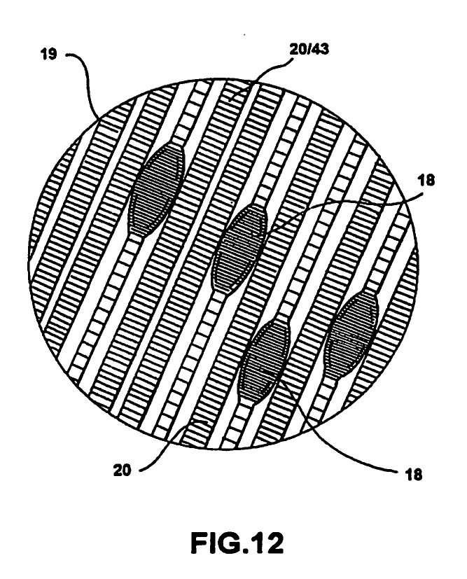

A trigger point 18 within a muscle 19 arises when over-stimulated or extended muscle fibers 20 are unable to release from their contracted state. See FIG. 12. This effect, as above noted, can range in dimension from the size of a pin head to that of a walnut. However, most trigger points exist as small lumps or nodules within the muscle or as groups thereof. A muscle fiber, in its normal resting state, is neither stretched nor contracted and as such defines a relatively linear tissue. As is more fully set forth below, certain muscle groups, including groups within the neck and back that are addressed by the present invention, recur as significant areas of trigger point distress. The nodules within muscle fiber defined by trigger points affect not simply the muscle per se but, as well, the means by which the muscle attaches to ligaments or bone. Thereby, the effect of a distressed trigger point is often transmitted to tissue which is some distance away—a phenomenon known as referred pain.

In general, muscle fiber is formed of a vast number of cells 43 known as sarcomeres which act as microscopic pumps, contracting and releasing, to facilitate the circulation of blood through the capillaries to supply their metabolic needs. However, when sarcomeres hold their contraction after a voluntary use of a muscle group has occurred, blood flow essentially stops in that immediate area, the result being oxygen starvation and accumulation of waste products of metabolism which in turn form and irritate the trigger point 18. Trigger point irritation, if untreated, enters an emergency mode by sending out pain signals until the brain institutes an instruction forcing the affected muscle to shut down. This is most typically felt as a shortening or tightening up of the affected muscle. Clearly, it is the interest of everyone, and fitness interested persons in particular, to take reasonable steps to prevent, minimize, or relieve the contraction of the sarcomeres of which all muscle fiber is formed.

Certain muscle groups of the shoulder, neck, upper, mid and lower back are particularly common areas of trigger point irritation.

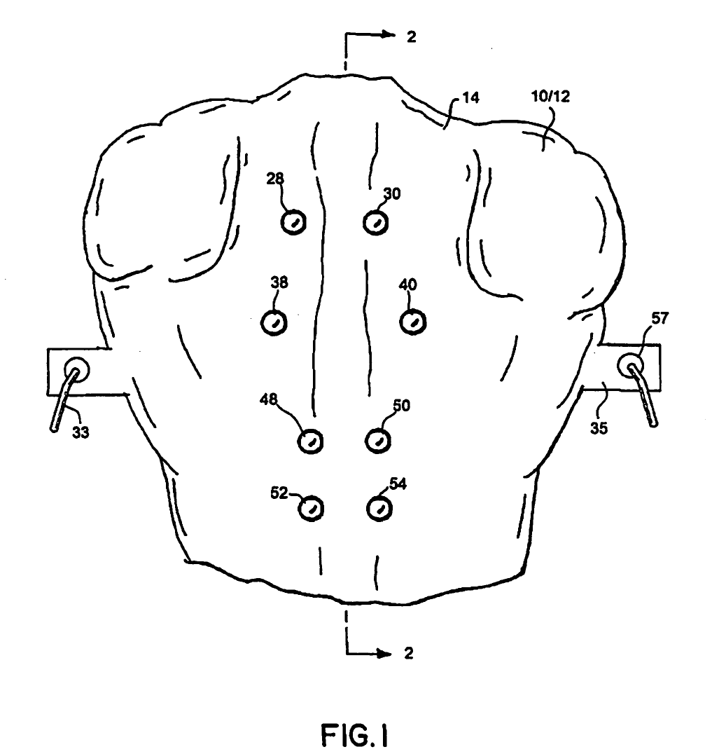

With reference to FIG. 1 may be seen the generalized appearance of the inventive system 10, which includes a shell 12, optionally having the appearance of muscles of the back, and a plurality of probes 14.

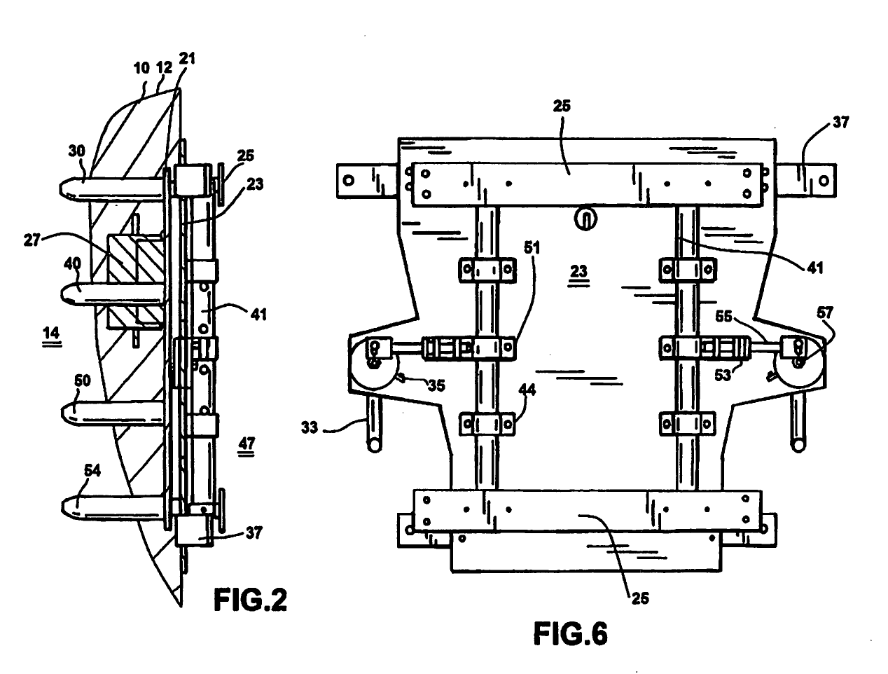

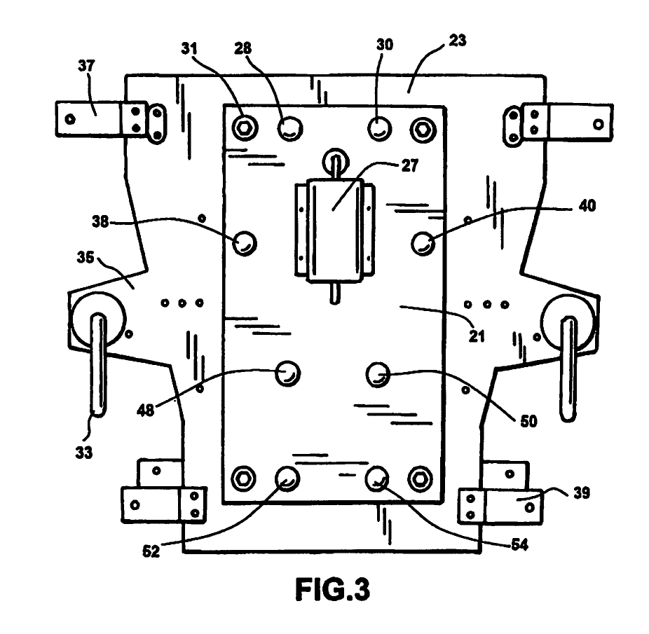

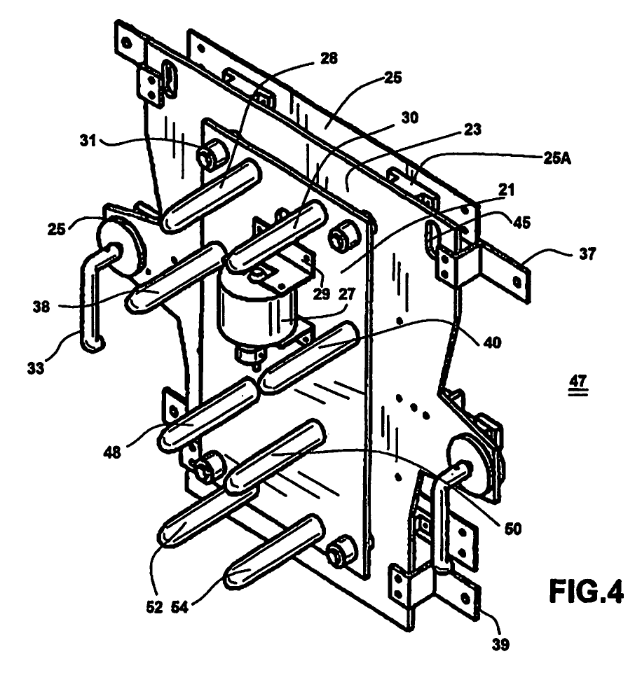

In FIG. 2 may be seen the relationship between an exterior shell 12 shown in FIG. 1, and a plurality of probes 14. In FIG. 2, probes 30, 40, 50 and 54 may be observed. The base of these probes are attached to the vibrating plate 21 which may be more fully appreciated with reference to the views of FIGS. 3 and 4. Upon vibrating plate 21 is secured a vibrating motor 27 (see also FIGS. 3, 4, and 5) which in turn is secured to the vibrating plate 21 by motor mounts 29 (see FIG. 4). Vibrating plate 21 is, through bolts 31, secured to a slidable plate 23 (see also FIGS. 2-6). That is, apertures 45 (see FIG. 4) within slidable plates 23 permit a measure of angular adjustability (relative to the vertical) of slidable plate 23, this in combination with upper brackets 37 which effect attachment of slidable plate 23 to a wall 47 (see FIG. 4). The lower portion of slidable plate is secured to wall 37 through the use of lower brackets 39.

As may be noted in the back view of FIG. 6, there are provided wall plates 25 which, together with said brackets 37 and 39, effect attachment of the vibrating assembly of the present system to wall 47. Between wall plates 25 and wall 47 are provided vertical pipes or members 41 (see FIG. 6) which are secured to sliding plate 23 by brackets 49.

Further shown in FIGS. 2 through 6 are handles 33 which are secured within projections 35 of sliding plate 23 (see FIG. 3). The position of said handles relative to the vertical may be controlled by a mechanism 53 (see FIG. 6) through which a change in the effective length of member 55 will change the position of circular base 57 of the handle 53, thereby altering its orientation relative to the vertical. For example, a non-vertical orientation of handles 33 is shown in the view of FIG. 1.

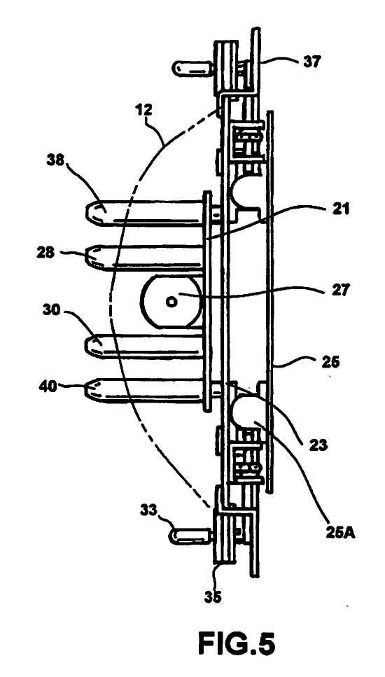

Shown in FIGS. 4 and 5 are damping bearings 25A which also provide an offset between sliding plate 23 and wall plates 25 and further provides a damping effect upon pressure applied to the back of the user by probes 14.

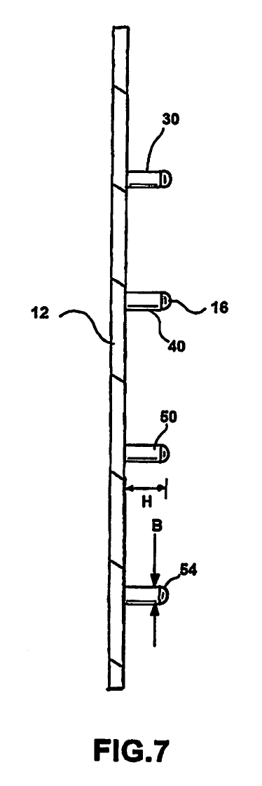

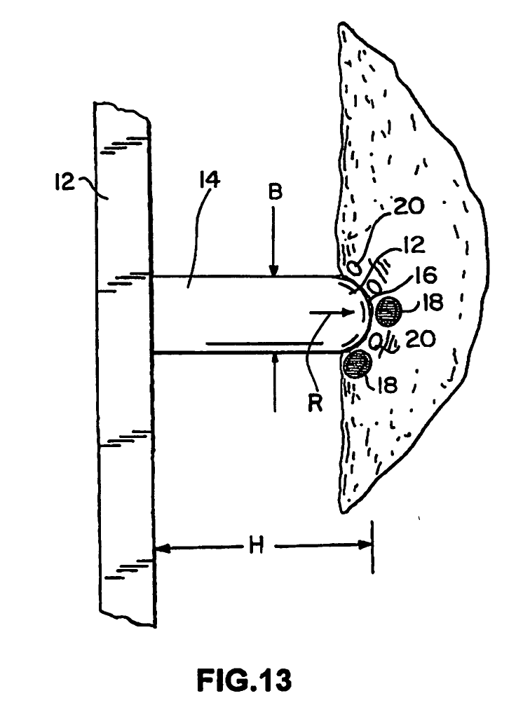

With reference to FIGS. 7 and 13, it may be seen that shell 12 directs all probes 14 and that each probe defines a height H of projection beyond shell 12, a base dimension B, and terminates in a rounded apex 16. The radius R of the apex 16 of each probe (see FIG. 13) must be carefully chosen so that the penetration effected thereby is neither too shallow to accomplish meaningful release of trigger point contraction nor too sharp as to cause injury to the user. As such, a preferred radius R of apex 16 of probe 14 is in the range of 3 to 15 millimeters. That is, the diameter of probe base B is in a range of 6 to 30 millimeters.

Shown in FIGS. 12 and 13 are contracted trigger points 18 as well as normal muscle fiber 20 therebetween. See FIG. 12. From FIGS. 7 and 13, it may be appreciated that selection of the proper radius R for the apex 16 of probe 14 is a material consideration in optimizing the function of the inventive device, as is the relation between probe extension height H and probe base diameter B. Typical values of H are in a range of 1 to 5 cm, so that the value of A is typically in a range of 2 to 3 times the value of B. Persons not concerned with, or unknowledgeable in regard to, optimizing release of trigger point contraction will typically employ probes having too great a radius. This is reflected in the above cited references to VandeBerg, Wang, Berke and Walquist. Some prior art, such as Lloyd above, teaches the use of massage probes that are pointed, such that their use requires a trained professional.

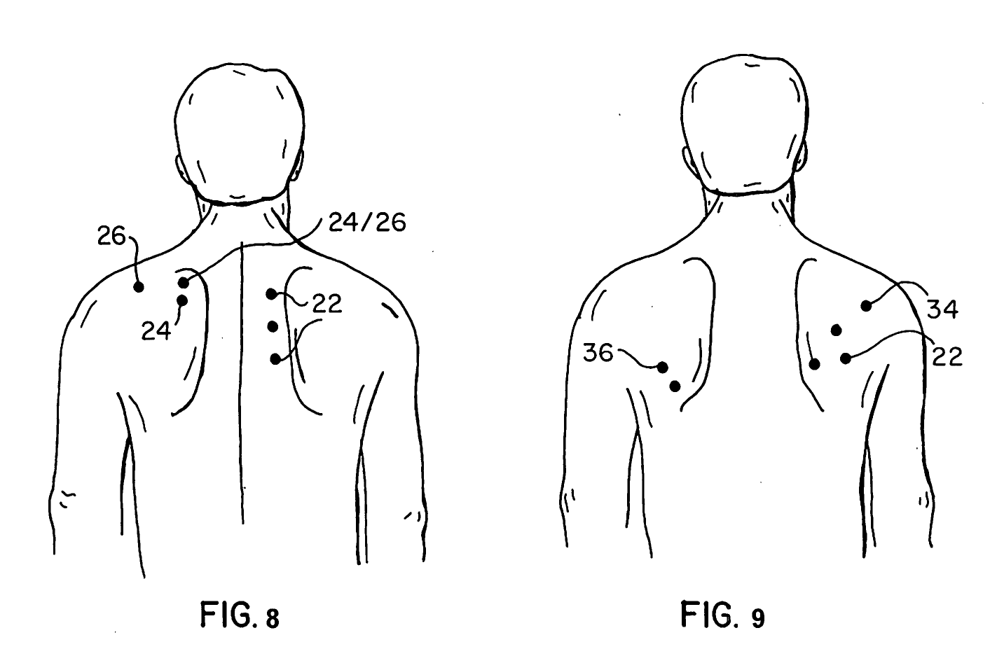

A full understanding of the instant invention requires an appreciation of the trigger points or trigger point groups which are salient in the muscle groups of the human back and which are most commonly sources of stress, strain, or referred pain by body builders and exercise-conscious individuals. More particularly, shown in FIG. 8 are rhomboid trigger points 22 which are located just inward of the shoulder blades. Shown to the left of FIG. 8 are a serratus posterior superior trigger point group 24 and a supraspinatus group 26. As may be noted, the serratus posterior superior group, at its inward portion, approaches the supraspinatus group. These muscle groups are common areas of trigger point pain in that the upper back and shoulders are used in many forms and types of exercise. These muscle groups are specifically accessible by probes 28 and 30 (see FIG. 1) particularly if one positions one's back to optimize contact with the affected muscle groups.

As may be appreciated with reference to FIG. 1, the instant invention provides absolute symmetry between the left and right sides of the device and the probes thereof. As such, even though the physiological illustrations of FIGS. 8-11 show muscle groups on either one or the other side of the back, it is to be understood the muscle groups of the back are completely symmetric thereby, even if a user of the instant device does so because of pain, tightness or the like in a given muscle group on one side of the back, the user may simultaneously effect a preventative treatment of the same muscle group on the opposite side of the back.

In FIG. 9 is shown infraspinatus trigger points 32 and teres minor trigger points 34. The teres major trigger points 36 are shown to the left of FIG. 9. Most of these muscle and trigger point groups may be readily reached by probes 38 and 40 of the device 10 (see FIG. 1), particularly if one moves one's back up and down relative to the base 12 of the device. Accordingly, it is anticipated that users will bend their knees or tilt their body as necessary to optimize contact between given symmetric probes or upper and lower probe groups and trigger points that are a cause of stiffness in a given area or in which the user, based upon personal historic experience, wishes to maximize flexibility of.

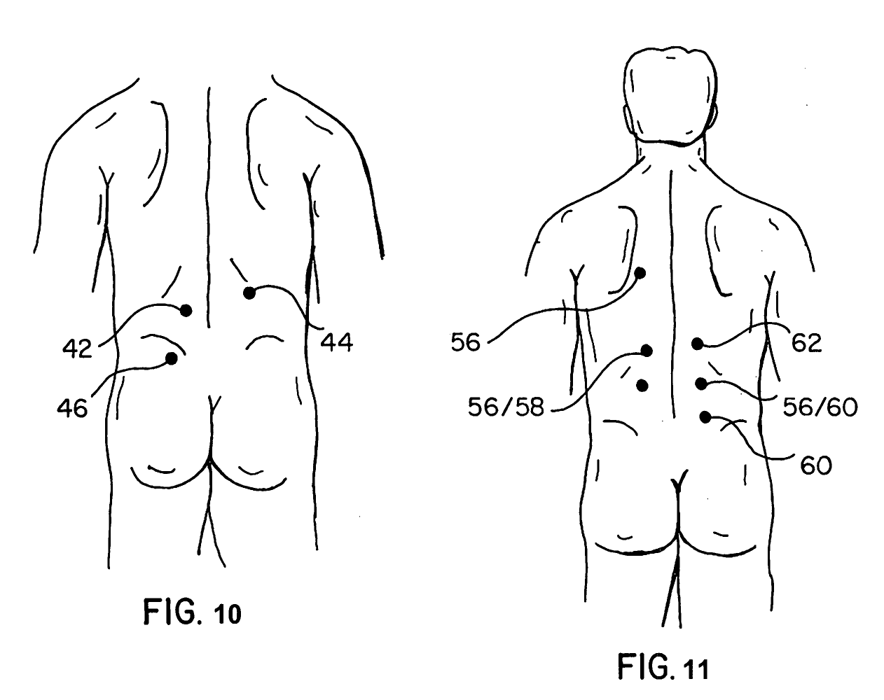

In FIG. 10 are shown lower back trigger points which include trigger point 42 associated with the multifidi muscle trigger point and associated with the levator costae muscle trigger point 44. Also shown is gluteus group 46. These, as are well known to athletes, are common sources of distress. These areas are addressed by probes 48, 50, 52 and 54 (see FIG. 1), understanding that each trigger point group shown in FIG. 10 exists symmetrically upon each side of the back. Accordingly, both the left and right of each trigger point group are concurrently treated by the use of the present device and, as well, one is able to address trigger points of multiple muscle groups at the same time.

In FIG. 11 is shown three somewhat separated trigger point groups 56, all however associated with the Iliocostalis muscle group. Trigger point 58 of the serratus posterior anterior trigger point exists near to the middle of the above-referenced iliocostalis group 56. Trigger point 60 relative to the quadratus lumborum muscle is also shown in FIG. 11. Further shown therein is trigger point 62 associated with the serratus posterior anterior muscle. As may be appreciated, all muscle groups shown in FIG. 11 are frequent issues to persons who exercise regularly, particularly in a gym using the array of exercise machinery that is commonly available.

It is further contemplated that the inventive device may be positioned upon a rack having attachment points at various heights, this to accommodate person of different heights. Similarly, the product may be offered in a number of sizes such as small, medium and large including a size particularly adapted to the female anatomy of the back.

It is to be appreciated that a squat frustoconical geometry for the probes 14 provides an alternative to spherical probe ends shown in FIG. 13. When molded integrally or properly attached to vibrating plate 21 exceedingly stable and possess a minimum torque arm. i.e., height H including apex 16 has little torque relative to plate 21 thereby improving both the stability of the device and its usable lifetime, unlike many of the probes in devices of the prior art which are substantially elongate and, as such, would have a minimal life in a gym or body building environment. As such, and as may be seen in FIGS. 7 and 12, the extension dimension H of the probe is generally about 2 to 3 times that of the diameter B of each probe, thus producing a sturdy and durable structure having an extended lifetime, particularly when molded of a properly selected polymer such as polycarbonate. As may be noted in FIG. 2, shell 12 also plays an important role in stabilizing the probes 14.

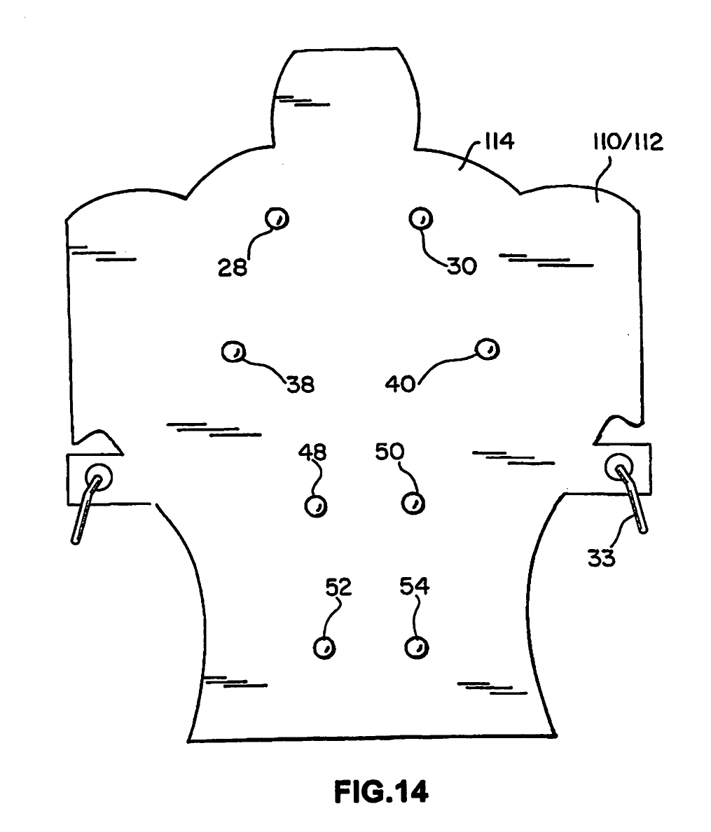

In FIG. 14 is shown a further embodiment 100 of the invention including a flat base 112 and a plurality of probes 44, all of which are similar in geometry and location to above described probes 28, 30, 38, 40, 48, 50, 52 and 54.

While there has been shown and described the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

1. An apparatus for the application of trigger point pressure, comprising:
a vibratory vertically mounted base provided with a horizontally symmetric plurality of probes positioned at physiologically relevant trigger point locations of the human back.

2. The apparatus as recited in claim 1 in which said plurality of probes comprise:
an array of trigger point probes symmetric about a central vertical plane of said base, said array comprising at least two of a pair of upper neck pair of probes, an upper back and shoulder blade pair of probes, a mid back pair of probes, and a lower back pair of probes.

3. The apparatus as recited in claim 2, further comprising:
a shell resembling the appearance of a human back, said shell provided with a plurality of apertures sufficient in dimension and location to permit slidable passage of said probes thru said shell; and
said vibratory base secured to a non-vibratory vertical base including lateral extensions extending into left and right handles by which a user of said apparatus may position and stabilize locations of his back requiring application of pressure to release of trigger point contractions.

4. The apparatus as recited in claim 3, in which an extension of each probe beyond said shell defines a length in a range of 2 to 3 times a diameter of each probe

5. The apparatus as recited in claim 3, in which a radius of curvature of an end of such probe is proportioned for optimal physiologic communication with a trigger point of a contracted muscle.

6. The apparatus as recited in claim 3, in which said radius defines a dimension of between about 3 mm and about 15 mm.

7. The apparatus as recited in claim 6 in which said base of each probe defines an extension of between about 1 and about 5 cm beyond said shell.
